(19) United States
(12) Patent Application Publication
(10) Pub. No.: US 2011/0086433 A1
(43) Pub. Date: Apr. 14, 2011

(54) Microfluidic chip

(76) Inventor: Jochen Rupp, Stuttgart (DE)

(21) Appl. No.: 12/924,649

(22) Filed: Oct. 1, 2010

(30) Foreign Application Priority Data
Oct. 14, 2009 (DE) DE 102009045685.6

(51) Int. Cl. G01N 1/10; B01L 3/00

(52) U.S. Cl. 436/180; 422/502; 422/547; 422/430

(57) ABSTRACT

A microfluidic chips (1), microfluidic fluid reservoirs (2), microfluidic kits (1,2) comprising a microfluidic chip (1) and a microfluidic fluid reservoir (2), and to methods of operating such microfluidic kits (1,2). According to the invention, at least either the microfluidic chip (1) or the microfluidic fluid reservoir (2) includes a distensible diaphragm (4) or a distensible wall region, respectively, which is distensible into the fluid reservoir (2), with volume displacement taking place, in order to move a fluid (8) out of the fluid reservoir (2) through the fluid channel inlet (6) into a fluid channel (7) of the microfluidic chip (1).

### BACKGROUND OF THE INVENTION

1. Field of the Invention

The present invention relates to microfluidic chips, microfluidic fluid reservoirs, microfluidic kits and methods for their operation.

2. Description of Related Art

Lab-on-a-chip (LOC) systems mostly consist of structured parts on which a biological or chemical analysis or production process takes place. In such systems, fluids are in most cases stored in sealed form on the chip itself or supplied to the chip through tubing. In that case, however, actuating the fluid and/or ensuring a sufficiently high sterility of the fluids may be problematic.

Published international patent application WO 99/017749 A1 describes a micromechanical valve for fluids.

### SUMMARY OF THE INVENTION

The present invention offers two-component solutions based on separation of microfluidic chip and fluid reservoir and fluid actuation by a distensible surface. Separation of chip and fluid reservoir may in that case have an advantageous effect on the storage and exchange of sensitive fluids, especially fluids containing biologically active reagents. A distensible surface enables simple and/or robust fluid actuation to be achieved together with a high level of sterility where required.

The present invention relates to a microfluidic chip including
a recess for receiving, especially detachably, a fluid reservoir, for example a fluid reservoir described hereinafter,
a distensible, especially an elastic, diaphragm adjoining the recess,
an actuator, and
a fluid channel inlet adjoining the recess,
   wherein the distensible diaphragm is distensible into the recess by the actuator with volume displacement taking place.

Advantageously, the actuating side may be separated from the fluid side by the distensible diaphragm, especially when an appropriately configured fluid reservoir which is described hereinafter is used. In that manner it is possible in turn to ensure a high sterility of the fluids used. In addition, in the case of a microfluidic chip of that kind, it is possible for fluids to be actuated in a simpler and/or more robust manner than is possible in the case of many known microfluidic chips. Furthermore, in the case of a microfluidic chip of that kind, if desired, the fluid reservoir may be opened and/or connected only directly before use, thereby simplifying storage and increasing the adaptability of the system.

The microfluidic chip may be especially a chip lab or lab-on-a-chip system, for example for the analysis of water and/or blood.

The recess may especially be configured in such a manner that a fluid reservoir may be pushed and/or snapped (clipped) and/or screwed into the recess, especially in a liquid-tight and/or gas-tight manner. In particular, the recess may be adapted to receive a fluid reservoir having a rigid wall region and an openable wall region or a fluid reservoir having a rigid wall region, a distensible, especially an elastic, wall region and an openable wall region. The distensible diaphragm is preferably adapted to contact, in the case of a fluid reservoir having a rigid and an openable wall region, the openable wall region and, in the case of a fluid reservoir having a rigid, a distensible and an openable wall region, the distensible wall region of a fluid reservoir mounted in the recess. The fluid channel inlet is in both cases preferably adapted to contact the openable wall region of a fluid reservoir mounted in the recess.

The microfluidic chip, especially the recess of the microfluidic chip, may furthermore have a groove and/or a tongue/projection in order to be connected to a microfluidic fluid reservoir by a complementary tongue/projection and/or groove of the microfluidic fluid reservoir, especially of a rigid wall region of the microfluidic fluid reservoir.

The distensible diaphragm may be distensible into a fluid reservoir disposed, especially mounted, in the recess, with volume displacement taking place, especially in order to move a fluid out of the fluid reservoir into the fluid channel inlet. The volume displaced by the distensible diaphragm may correspond to the volume of fluid moved. Insofar as the fluid container contains a gas, for example air, in addition to liquid, owing to compression of the gas the volume of fluid moved may be less than the volume displaced by the distensible diaphragm.

The actuator may both be integrated in the distensible diaphragm and be separate from the distensible diaphragm, for example adjoining the distensible diaphragm. For example, the actuator may be a pneumatic actuator (for example an actuator operated with external compressed air), a thermal actuator (for example an actuator operated by the generation of gas), a piezoelectric actuator and/or a mechanical actuator.

In one embodiment, the actuator includes a pressure channel adjoining the distensible diaphragm. By applying a pressure to the pressure channel the distensible diaphragm may thus be distended into the recess in a simple manner with volume displacement taking place.

The fluid channel inlet may, for example, be configured in such a manner that the fluid inlet channel opens when a fluid reservoir is received and/or closes when a fluid reservoir is removed. For example, the fluid channel inlet may be configured in such a manner that on the basis of a mechanical mechanism the fluid channel inlet opens when a fluid reservoir is received and closes again when the fluid reservoir is removed. That advantageously makes it possible to prevent contaminants from entering the fluid channel and prevent fluid from flowing back into the cavity from the fluid channel when the fluid reservoir is being changed. The fluid channel inlet may, in addition or as an alternative, be of a valve-type configuration. For example, the fluid channel inlet may have a perforated, elastic diaphragm the perforations of which are impermeable to fluid under normal pressure and are permeable to fluid when acted upon by a given pressure, especially by virtue of enlargement due to distension.

### BRIEF DESCRIPTION OF THE DRAWINGS

Further advantages and advantageous configurations of the subject-matter of the invention are illustrated by the drawings and are described in the description which follows. It should be noted that the drawings are merely of a descriptive nature and are not intended to limit the invention in any way. In the drawings:

FIG. 1a shows a schematic cross-section through a first configuration of a microfluidic fluid reservoir according to the invention;

FIG. 1b shows a schematic cross-section through a first configuration of a microfluidic chip according to the invention;

FIG. 1c shows a schematic cross-section through a first configuration of a microfluidic kit according to the invention, which is composed of the fluid reservoir shown in

FIG. 1a and the chip shown in FIG. 1b, in the unactuated state;

FIG. id shows a schematic cross-section through the kit shown in FIG. 1c, in the actuated state;

FIG. 2a shows a schematic cross-section of a second configuration of a microfluidic fluid reservoir according to the invention;

FIG. 2b shows a schematic cross-section through a second configuration of a microfluidic chip according to the invention;

FIG. 2c shows a schematic cross-section through a second configuration of a microfluidic kit according to the invention, which is composed of the fluid reservoir shown in FIG. 2a and the chip shown in FIG. 2b, in the unactuated state;

FIG. 2d shows a schematic cross-section through the kit shown in FIG. 2c, in the actuated state;

FIG. 3a is an enlarged, schematic, perspective view of the first configuration of the microfluidic chip according to the invention; and

FIG. 3b is a schematic, perspective view of the first configuration of the microfluidic kit according to the invention.

### DETAILED DESCRIPTION OF THE INVENTION

The present invention further relates to a microfluidic fluid reservoir, for example a microfluidic fluid reservoir partially or completely filled with a fluid, to be received, especially detachably, in a recess of a microfluidic chip described above. In one embodiment, the fluid reservoir has a rigid wall region and an openable wall region, the openable wall region being adapted to contact, when in the mounted state in the recess of the microfluidic chip, the distensible diaphragm and the fluid channel inlet of the microfluidic chip. In another embodiment, the fluid reservoir has a rigid wall region, a distensible, especially an elastic, wall region and an openable wall region, the distensible wall region being adapted to contact, when in the mounted state in the recess of the microfluidic chip, the distensible diaphragm of the microfluidic chip, especially to form a double diaphragm, and the openable wall region being adapted to contact, when in the mounted state in the recess of the microfluidic chip, the fluid channel inlet of the microfluidic chip.

A sealed microfluidic fluid reservoir of that kind may advantageously be kept sterile more easily, thereby simplifying the storage of sensitive fluids.

The microfluidic fluid reservoir, especially the rigid wall region of the microfluidic fluid reservoir, may have a groove and/or a tongue/projection in order to be connected to a microfluidic chip by a complementary tongue/projection and/or groove of the microfluidic chip, especially of a recess of the microfluidic chip.

In a further embodiment, the openable wall region is in the form of a reversibly or irreversibly openable cover or in the form of a reversibly or irreversibly openable diaphragm.

For example, a reversibly openable cover may be configured in such a manner that on the basis of a mechanical mechanism, for example by displacement of the cover, the cover opens when the fluid reservoir is received in a recess of a microfluidic chip and closes again when the fluid reservoir is removed from a recess of a microfluidic chip.

An irreversibly openable cover may, for example, be configured in such a manner that on the basis of a mechanical mechanism, for example by removal or displacement of the cover, the cover opens when the fluid reservoir is received in a recess of a microfluidic chip.

A reversibly openable diaphragm may, for example, be a perforated, elastic diaphragm the perforations of which are impermeable to fluid under normal pressure and are permeable to fluid when acted upon by a given pressure, especially by virtue of enlargement due to distension.

An irreversibly openable diaphragm may, for example, be a diaphragm that is destroyed and therefore opened when the fluid reservoir is actuated or received in a recess of a microfluidic chip.

The present invention further relates to a microfluidic chip of an alternative configuration according to the invention in which—as in the case of the microfluidic chip in the first-described configuration according to the invention—a fluid is actuated out of a fluid reservoir by a distensible surface. In contrast to the microfluidic chip of the first-described configuration according to the invention, in this case, however, the distensible surface is a component part of the wall of the fluid reservoir and is not a component part of the chip itself. The microfluidic chip of the alternative configuration according to the invention especially includes
a recess for receiving, especially detachably, a fluid reservoir having a rigid wall region, a distensible, especially an elastic, wall region and an openable wall region, for example of the alternative configuration described hereinafter,
an actuator adjoining the recess, and
a fluid channel inlet adjoining the recess,
   wherein the distensible wall region of a fluid reservoir disposed, especially mounted, in the recess is distensible into the fluid reservoir by the actuator with volume displacement taking place.

In the case of a microfluidic chip of that kind also, the actuating side may advantageously be separated from the fluid side by the distensible wall region when an appropriately configured fluid reservoir which is described hereinafter is used. In that manner it is possible in turn to ensure a high sterility of the fluids used. In addition, in the case of a microfluidic chip of that kind also, it is possible for fluids to be actuated in a simpler and/or more robust manner than is possible in the case of many known microfluidic chips. Furthermore, in the case of a microfluidic chip of that kind also, if desired, the fluid reservoir may be opened and/or connected only directly before use, thereby simplifying storage and increasing the adaptability of the system.

The microfluidic chip may in this case also be a chip lab or lab-on-a-chip system, for example for the analysis of water and/or blood.

The recess may in this case also be configured in such a manner that a fluid reservoir may be pushed and/or snapped (clipped) and/or screwed into the recess, especially in a liquid-tight and/or gas-tight manner.

The microfluidic chip, especially the recess of the microfluidic chip, may in this case also have a groove and/or a tongue/projection in order to be connected to a microfluidic fluid reservoir by a complementary tongue/projection and/or groove of the microfluidic fluid reservoir, especially of a rigid wall region of the microfluidic fluid reservoir.

The actuator may in this case also be a pneumatic actuator (for example an actuator operated with external compressed air), a thermal actuator (for example an actuator operated by the generation of gas), a piezoelectric actuator and/or a mechanical actuator.

In one embodiment, the actuator includes in this case also a pressure channel adjoining the recess. By applying a pressure to the pressure channel, a distensible, especially an elastic, wall region of a fluid reservoir mounted in the recess may be distended into the recess in a simple manner with volume displacement taking place. The actuator may be adapted to contact a distensible, especially an elastic, wall region of a fluid reservoir mounted in the recess.

In this case also, the fluid channel inlet may, for example, be configured in such a manner that the fluid inlet channel opens when a fluid reservoir is received and/or closes when a fluid reservoir is removed. For example, the fluid channel inlet may be configured in such a manner that on the basis of a mechanical mechanism the fluid channel inlet opens when a fluid reservoir is received and closes again when the fluid reservoir is removed. That advantageously makes it possible to prevent contaminants from entering the fluid channel and prevent fluid from flowing back into the cavity from the fluid channel when the fluid reservoir is being changed. The fluid channel inlet may, in addition or as an alternative, be of a valve-type configuration. For example, the fluid channel inlet may have a perforated, elastic diaphragm the perforations of which are impermeable to fluid under normal pressure and are permeable to fluid when acted upon by a given pressure, especially by virtue of enlargement due to distension. The fluid channel inlet is preferably adapted to contact the openable wall region of a fluid reservoir mounted in the recess.

The present invention further relates to a microfluidic fluid reservoir, for example a microfluidic fluid reservoir partially or completely filled with a fluid, of an alternative configuration according to the invention which is adapted to be received, especially detachably, in a recess of a microfluidic chip of the alternative configuration according to the invention. A microfluidic fluid reservoir of the alternative configuration according to the invention has especially a rigid wall region, a distensible, especially an elastic, wall region, and an openable wall region, the distensible wall region being adapted to contact, when in the mounted state in the recess of the microfluidic chip, the actuator of the microfluidic chip, and the openable wall region being adapted to contact, when in the mounted state in the recess of the microfluidic chip, the fluid channel inlet of the microfluidic chip.

In particular, a sealed microfluidic fluid reservoir of that kind may advantageously be kept sterile more easily, thereby simplifying the storage of sensitive fluids.

The microfluidic fluid reservoir, especially the rigid wall region of the microfluidic fluid reservoir, may in this case also have a groove and/or a tongue/projection in order to be connected to a microfluidic chip by a complementary tongue/projection and/or groove of the microfluidic chip, especially of a recess of the microfluidic chip.

In one embodiment, the openable wall region is in this case also in the form of a reversibly or irreversibly openable cover or in the form of a reversibly or irreversibly openable diaphragm.

For example, in this case also, a reversibly openable cover may be configured in such a manner that on the basis of a mechanical mechanism, for example by displacement of the cover, the cover opens when the fluid reservoir is received in a recess of a microfluidic chip and closes again when the fluid reservoir is removed from a recess of a microfluidic chip.

In this case also, an irreversibly openable cover may, for example, be configured in such a manner that on the basis of a mechanical mechanism, for example by removal or displacement of the cover, the cover opens when the fluid reservoir is received in a recess of a microfluidic chip.

In this case also, a reversibly openable diaphragm may, for example, be a perforated, elastic diaphragm the perforations of which are impermeable to fluid under normal pressure and are permeable to fluid when acted upon by a given pressure, especially by virtue of enlargement due to distension.

In this case also, an irreversibly openable diaphragm may be a diaphragm that is destroyed and therefore opened when the fluid reservoir is actuated or received in a recess of a microfluidic chip.

The present invention further relates to a microfluidic kit/system that includes a microfluidic chip of the first-described configuration according to the invention and a microfluidic fluid reservoir of the first-described configuration according to the invention, or a microfluidic chip of the alternative configuration according to the invention and a microfluidic fluid reservoir of the alternative configuration according to the invention. The two parts may be fabricated and filled separately from each other or may be manufactured together.

The present invention further relates to a method for operating a microfluidic kit/system according to the invention, including the steps of:
a) inserting, especially pushing and/or snapping (clipping) and/or screwing, the fluid reservoir into the recess of the microfluidic chip,
b) distending the distensible diaphragm of the microfluidic chip and/or the distensible wall region of the fluid reservoir into the fluid reservoir with volume displacement taking place, and
c) moving fluid out of the fluid reservoir through the fluid channel inlet into the fluid channel of the microfluidic chip.

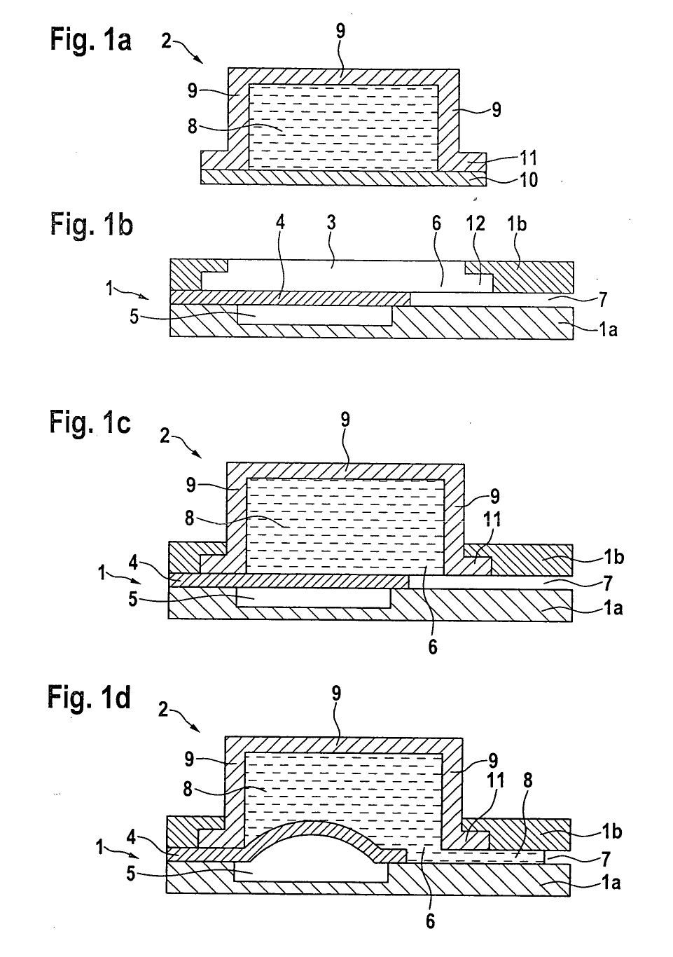

FIG. 1a shows a first configuration of a microfluidic fluid reservoir 2 according to the invention. FIG. 1a shows that fluid reservoir 2 has a rigid wall region 9 and an openable wall region 10 and is completely filled with a fluid 8. Openable wall region 10 is in the form of a reversibly or irreversibly openable cover 10. FIG. 1a further shows that rigid wall region 9 of microfluidic fluid reservoir 2 has a tongue/projection 11 in order to be connected to a microfluidic chip 1, described hereinafter, by a complementary groove 12 of recess 3 of microfluidic chip 1.

FIG. 1b shows a first configuration of a microfluidic chip 1 according to the invention, which includes a recess 3 for receiving a fluid reservoir 2, a distensible diaphragm 4 adjoining recess 3, an actuator 5, and a fluid channel inlet 6 adjoining recess 3. FIG. 1b further shows that actuator 5 includes a pressure channel 5 adjoining distensible diaphragm 4. FIG. 1b also shows that distensible diaphragm 4 is distensible by actuator 5 or pressure channel 5 into recess 3 with volume displacement taking place. FIG. 1b further illustrates that microfluidic chip 1 may be made up of a structured base substrate 1a and a structured overlay substrate 1b, with distensible diaphragm 4 being disposed between base substrate and overlay substrate 1b.

FIG. 1c shows a first configuration of a microfluidic kit according to the invention, in the unactuated state. FIG. 1c illustrates that the assembly relies on microfluidic fluid reservoir 2 according to the invention shown in FIG. 1a being introduced into recess 3 of microfluidic chip 1 according to the invention shown in FIG. 1b, and thereby being mounted. FIG. 1c further illustrates that fluid reservoir 2 shown in FIG. 1a is adapted to be received in recess 3 of chip 1 shown in FIG. 1b, with openable wall region 10 of fluid reservoir 2 contacting—in the mounted state of fluid reservoir 2 in recess 3 of microfluidic chip 1 —distensible diaphragm 4 and fluid channel inlet 6 of microfluidic chip 1. At the same time, rigid wall regions 9 contact the side walls of recess 3 at least partly.

FIG. 1d shows the kit of FIG. 1c in the actuated state. FIG. 1d illustrates that, by applying a pressure to pressure channel 5, distensible diaphragm 4 may be distended into fluid reservoir 2 mounted in recess 3, with volume displacement taking place, in order in that manner to move a fluid 8 out of fluid reservoir 2 through fluid channel inlet 6 into a fluid channel 7.

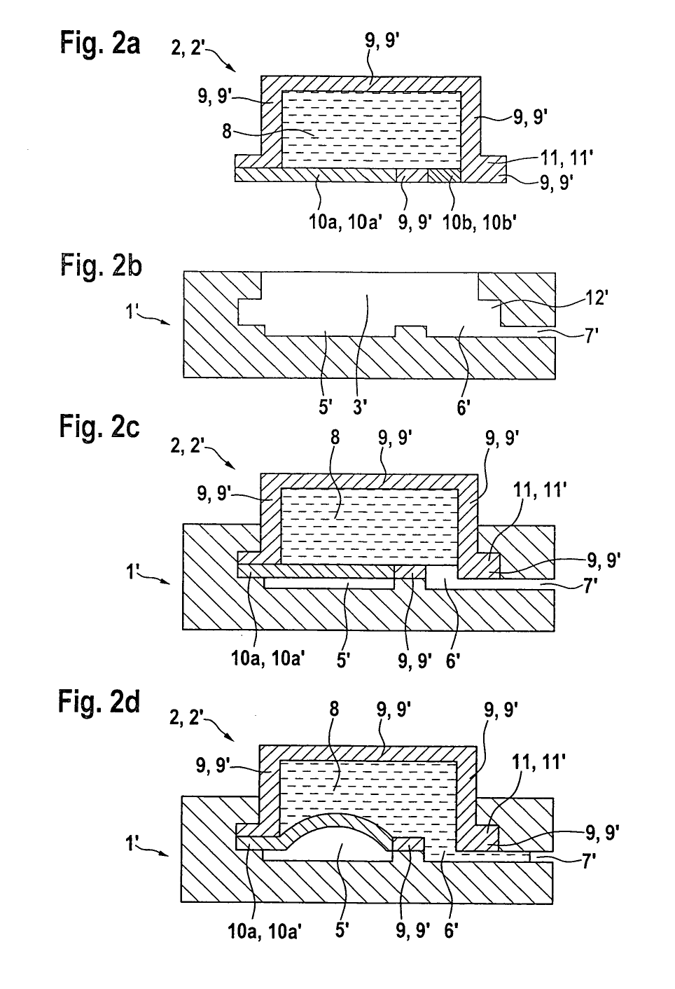

FIG. 2a shows a second configuration of a microfluidic fluid reservoir 2,2′ according to the invention. A fluid reservoir of such a configuration may advantageously be used both with the first embodiment of a microfluidic chip 1 according to the invention, which is described above, and with the second embodiment of a microfluidic chip 1′ according to the invention, which is described in detail hereinafter. FIG. 2a shows that that fluid reservoir 2,2′ has a rigid wall region 9,9′, a distensible, especially an elastic, wall region 10a,10a′ and an openable wall region 10b,10b′, and is completely filled with a fluid 8. Openable wall region 10b,10b′ is adapted to contact fluid channel inlet 6,6′ of a′ chip according to the invention of the first 1 or second 1′ configuration. Distensible wall region 10a,10a′ is adapted to contact distensible diaphragm 4 of a chip 1 according to the invention of the first configuration or actuator 5′ of a chip 1′ according to the invention of the second configuration which is described in detail hereinafter. In the case of mounting in a chip 1′ according to the invention of the first configuration, two distensible surfaces, namely distensible diaphragm 4 of microfluidic chip 1 and distensible wall region 10a of the microfluidic fluid reservoir, then lie against each other and form a “double diaphragm”. FIG. 2a further shows that rigid wall region 9,9′ of microfluidic fluid reservoir 2,2′ has a tongue/projection 11,11′ in order to be connected to a microfluidic chip 1′, described hereinafter, by a complementary groove 12′ of recess 3′ of microfluidic chip 1′.

FIG. 2b shows a second configuration of a microfluidic chip 1′ according to the invention. FIG. 2b shows that microfluidic chip 1′ has a recess 3′ for receiving a fluid reservoir 2,2′ shown in FIG. 2a and having a rigid wall region 9,9′, a distensible, especially an elastic, wall region 10a,10a′, and an openable wall region 10b,10b′, an actuator 5′ adjoining recess 3′, and a fluid channel inlet 6′ adjoining recess 3′. Actuator 5′ is adapted to contact a distensible wall region 10a,10a′ of a fluid reservoir 2,2′ mounted in recess 3′. FIG. 2b further shows that actuator 5′ includes a pressure channel 5′ adjoining recess 3′. FIG. 2b also shows that, by applying a pressure to pressure channel 5′, a distensible wall region 10a,10a′ of a fluid reservoir 2,2′ mounted in the recess may be distended into fluid reservoir 2,2′ in a simple manner with volume displacement taking place.

FIG. 2c shows a second configuration of a microfluidic kit according to the invention, in the unactuated state. FIG. 2c illustrates that the assembly relies on microfluidic fluid reservoir 2,2′ according to the invention shown in FIG. 2a being introduced into recess 3′ of microfluidic chip 1′ shown in FIG. 2b and thereby being mounted.

FIG. 2d shows the kit of FIG. 2c in the actuated state. FIG. 2d illustrates that, by applying a pressure to pressure channel 5′, distensible wall region 10a,10a′ may be distended into fluid reservoir 2,2′ mounted in recess 3′, with volume displacement taking place, in order in that manner to move a fluid 8 out of fluid reservoir 2,2′ through fluid channel inlet 6′ into a fluid channel 7′. FIG. 2d further shows that openable wall region 10b,10b′ was in the form of an irreversibly openable diaphragm which was destroyed and therefore opened on actuation of fluid 8.

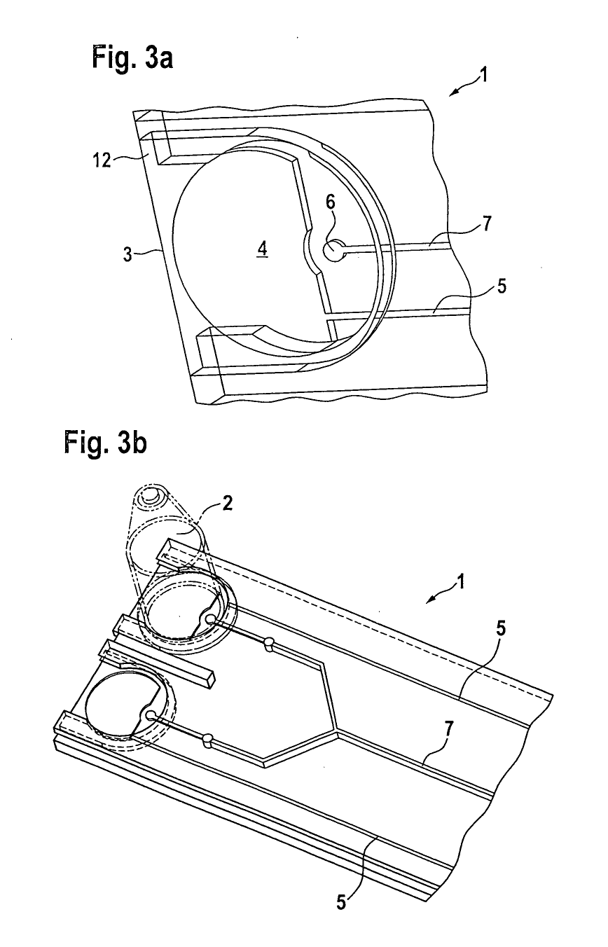

FIG. 3a is an enlarged, schematic, perspective view of the first configuration of microfluidic chip 1 according to the invention, having a pressure chamber 5 covered by a distensible diaphragm 4. FIG. 3a illustrates that recess 3 of microfluidic chip 1 has a groove 12 in order to be connected to a microfluidic fluid reservoir 2 by a complementary tongue/projection 11 of microfluidic fluid reservoir 2.

FIG. 3b shows a larger portion of microfluidic chip 1 shown in FIG. 3a, after a microfluidic fluid reservoir 2 having a tongue/projection 11 has been pushed into recess 3 and groove 12 thereof.

What is claimed is:

1. A microfluidic chip, comprising:
a recess for receiving a fluid reservoir,
a distensible diaphragm adjoining the recess,
an actuator, and
a fluid channel inlet adjoining the recess,
wherein the distensible diaphragm is distensible into the recess by the actuator with volume displacement taking place.

2. The microfluidic chip as recited in claim 1, wherein the actuator includes a pressure channel adjoining the distensible diaphragm.

3. A microfluidic fluid reservoir to be received in a recess of a microfluidic chip as recited in claim 1, comprising:
a rigid wall region and an openable wall region, the openable wall region being adapted to contact, when in a mounted state in the recess of the microfluidic chip, the distensible diaphragm and the fluid channel inlet of the microfluidic chip.

4. A microfluidic fluid reservoir to be received in a recess of a microfluidic chip as recited in claim 1, comprising:
a rigid wall region, a distensible wall region and an openable wall region, the distensible wall region being adapted to contact, when in a mounted state in the recess of the microfluidic chip, the distensible diaphragm of the microfluidic chip, and the openable wall region being adapted to contact, when in a mounted state in the recess of the microfluidic chip, the fluid channel inlet of the microfluidic chip.

5. The microfluidic fluid reservoir as recited in claim 3, wherein the openable wall region is in the form of a reversibly or irreversibly openable cover or in the form of a reversibly or irreversibly openable diaphragm.

6. The microfluidic fluid reservoir as recited in claim 4, wherein the openable wall region is in the form of a reversibly or irreversibly openable cover or in the form of a reversibly or irreversibly openable diaphragm.

7. A microfluidic fluid reservoir to be received in a recess of a microfluidic chip as recited in claim 2, comprising:
a rigid wall region and an openable wall region, the openable wall region being adapted to contact, when in a mounted state in the recess of the microfluidic chip, the distensible diaphragm and the fluid channel inlet of the microfluidic chip.

8. A microfluidic fluid reservoir to be received in a recess of a microfluidic chip as recited in claim 2, comprising:
a rigid wall region, a distensible wall region and an openable wall region, the distensible wall region being adapted to contact, when in a mounted state in the recess of the microfluidic chip, the distensible diaphragm of the microfluidic chip, and the openable wall region being adapted to contact, when in a mounted state in the recess of the microfluidic chip, the fluid channel inlet of the microfluidic chip.

9. The microfluidic fluid reservoir as recited in claim 7, wherein the openable wall region is in the form of a reversibly or irreversibly openable cover or in the form of a reversibly or irreversibly openable diaphragm.

10. The microfluidic fluid reservoir as recited in claim 8, wherein the openable wall region is in the form of a reversibly or irreversibly openable cover or in the form of a reversibly or irreversibly openable diaphragm.

11. A microfluidic chip comprising:
a recess for receiving a fluid reservoir having a rigid wall region, a distensible wall region and an openable wall region,
an actuator adjoining the recess, and
a fluid channel inlet adjoining the recess,
wherein the distensible wall region of a fluid reservoir disposed in the recess is distensible into the fluid reservoir by the actuator with volume displacement taking place.

12. The microfluidic chip as recited in claim 11, wherein the actuator includes a pressure channel adjoining the recess.

13. A microfluidic fluid reservoir to be received in a recess of a microfluidic chip as recited in claim 11, comprising: a rigid wall region, a distensible wall region and an openable wall region, the distensible wall region being adapted to contact, when in a mounted state in the recess of the microfluidic chip, the actuator of the microfluidic chip, and the openable wall region being adapted to contact, when in a mounted state in the recess of the microfluidic chip, the fluid channel inlet of the microfluidic chip.

14. A microfluidic fluid reservoir to be received in a recess of a microfluidic chip as recited in claim 12, comprising: a rigid wall region, a distensible wall region and an openable wall region, the distensible wall region being adapted to contact, when in a mounted state in the recess of the microfluidic chip, the actuator of the microfluidic chip, and the openable wall region being adapted to contact, when in a mounted state in the recess of the microfluidic chip, the fluid channel inlet of the microfluidic chip.

15. The microfluidic fluid reservoir as recited in claim 13, wherein the openable wall region is in the form of a reversibly or irreversibly openable cover or in the form of a reversibly or irreversibly openable diaphragm.

16. The microfluidic fluid reservoir as recited in claim 14, wherein the openable wall region is in the form of a reversibly or irreversibly openable cover or in the form of a reversibly or irreversibly openable diaphragm.

17. A microfluidic kit comprising: a microfluidic chip as recited in claim 1 and a microfluidic reservoir as recited in claim 3.

18. A microfluidic kit comprising: a microfluidic chip as recited in claim 11 and a microfluidic reservoir as recited in claim 13.

19. A method for operating a microfluidic kit as recited in claim 17, comprising:
a) inserting the fluid reservoir into the recess of the microfluidic chip,
b) distending the distensible diaphragm of the microfluidic chip or the distensible wall region of the fluid reservoir into the fluid reservoir with volume displacement taking place, and
c) moving fluid out of the fluid reservoir through the fluid channel inlet into the fluid channel of the microfluidic chip.

20. A method for operating a microfluidic kit as recited in claim 18, comprising:
a) inserting the fluid reservoir into the recess of the microfluidic chip,
b) distending the distensible diaphragm of the microfluidic chip or the distensible wall region of the fluid reservoir into the fluid reservoir with volume displacement taking place, and
c) moving fluid out of the fluid reservoir through the fluid channel inlet into the fluid channel of the microfluidic chip.
